(19) United States
(12) Patent Application Publication
(10) Pub. No.: US 2009/0183060 A1
(43) Pub. Date: Jul. 16, 2009

(54) Unified Media Presentation for Media Devices

(76) Inventors: David Heller, Los Altos, CA (US); Jeffrey L. Robbin, Los Altos, CA (US); Christopher R. Wysocki, Los Gatos, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/013,441

(22) Filed: Jan. 12, 2008

(51) Int. Cl. G06F 17/00

(52) U.S. Cl. 715/202

(57) ABSTRACT

Improved methods, systems, computer readable media and graphical user interfaces for presenting digital media assets in a consistent and/or unified manner regardless of whether the digital media assets are located locally or remotely. Users are thus provided with information on those digital media assets that are available to users regardless of whether the digital media assets are located locally or remotely. As digital media assets become available or unavailable, presentations of the digital media assets can be automatically updated. For example, a presentation of digital media assets available to a media device for playback can be dynamically updated.

### COPYRIGHT NOTICE

A portion of the disclosure of this patent document contains material which is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

1. Field of the Invention

The present invention relates to media devices and, more particularly, to media presentation on media devices.

2. Description of the Related Art

Personal computers utilize file systems to manage the various digital files stored by the personal computer. While most digital files used by a personal computer are stored on a data storage device, such as a hard disk drive or FLASH memory, internal to the personal computer, removable data storage devices can also be connected to the personal computer. Examples of removable data storage include portable hard drives, memory cards, memory sticks, etc. As a removable data storage device is connected, the personal computer recognizes the removable data storage device and digital files stored to the removable data storage device can be made available to the personal computer. For example, when a removable data storage device is connected, a list of the digital files stored to the removable data storage device can be displayed for the user of the personal computer. However, once the removable data storage device is disconnected, all the digital files stored to the removable data storage device become unavailable and thus the list of the digital files stored to the removable data storage device is no longer available.

Set-top boxes can also present a list of digital assets available to the set-top boxes. Typically, the digital assets are stored at the set-top boxes. However, some media devices that offer media playback can also access digital assets located remotely. For example, AppleTV™ media device is an example of a set-top box or media device that can permit a user to access and/or playback digital media assets. However, in doing so, the user enters either a local mode or remote mode. In the local mode, digital assets stored locally at the AppleTV™ media device can be displayed for a user. In the remote mode, digital assets stored remotely on an associated personal computer (but connected to the AppleTV™ media device) can be displayed for the user. Unfortunately, however, a user is required to switch between these modes to be presented with and/or access digital assets that are accessible by the media device. Thus, there is a need for improved techniques to present a user with digital assets that are available at media devices.

### SUMMARY OF THE INVENTION

The invention relates to methods, systems, computer readable media and graphical user interfaces for presenting digital media assets in a consistent and/or unified manner regardless of whether the digital media assets are located locally or remotely. Users are thus provided with information on those digital media assets that are available to users regardless of whether the digital media assets are located locally or remotely. As digital media assets become available or unavailable, presentations of the digital media assets can be automatically updated. For example, a presentation of digital media assets available to a media device for playback can be dynamically updated.

The invention can be implemented in numerous ways, including as a method, system, device, apparatus (including graphical user interface or computer readable medium). Several embodiments of the invention are discussed below.

As a method for presenting a digital media asset on a media playback device, one embodiment of the invention can, for example, include at least: obtaining a list of digital media assets that are available to the media playback device, at least one of the digital media assets being stored locally at the media playback device, and at least one of the digital media assets being stored remotely at a remote media management device; presenting the list of digital media assets to a user of the media playback device; receiving a selection of at least one of the digital media assets to be played; and determining whether the selected digital media asset is stored locally at the media playback device or stored remotely at the remote media management device. If it is determined that the selected digital media asset is stored remotely at the remote media management device, then digital content of the selected digital media asset can be streamed from the remote media management device to the media playback device so as to playback the selected digital media asset on the media playback device. If it is determined that the selected digital media asset is stored locally at the media playback device, then digital content of the selected digital media asset can be retrieved from the media playback device so as to playback the selected digital media asset on the media playback device.

As a method for dynamically displaying a list of digital media assets at a media playback device, one embodiment of the invention can, for example, include at least: determining whether a remote media management device is available to the media playback device via a network connection; obtaining a list of digital media assets that are available to the media playback device, the list including one or more digital media assets stored locally at the media playback device, and the list including at least one or more digital media assets stored remotely at the remote media management device provided it is determined that the remote media management device is available to the media playback device; presenting the list of digital media assets to a user of the media playback device; determining whether the remote media management device is no longer available to the media playback device; and dynamically updating the list of digital media assets being displayed if it is determined that the remote media management device is no longer available to the media playback device, such that the list of digital media assets includes only the one or more digital media assets stored locally at the media playback device and thus no longer includes any digital media assets stored remotely at the remote media management device.

Other aspects and embodiments of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media system according to one embodiment of the invention.

FIGS. 2A and 2B are flow diagrams of a digital asset presentation and playback process according to one embodiment of the invention.

FIG. 2C is an exemplary preference setting screen according to one embodiment of the invention.

FIG. 3 is an exemplary representation of a media database according to one embodiment of the invention.

FIG. 4 is a flow diagram of a media asset playback process according to one embodiment of the invention.

FIGS. 5A and 5B are flow diagrams of a synchronization process according to one embodiment of the invention.

FIG. 6A is a flow diagram of a media asset determination process according to one embodiment of the invention.

FIG. 6B is a flow diagram of a media asset prioritization process according to one embodiment of the invention.

FIGS. 6C and 6D illustrate a first category synchronization process according to one embodiment of the invention.

FIGS. 6E and 6F illustrate a flow diagram of a second category synchronization process according to one embodiment of the invention.

FIG. 7 is a block diagram of a mobile multi-function device according to one embodiment of the invention.

### DETAILED DESCRIPTION OF THE INVENTION

The invention relates to methods, systems, computer readable media and graphical user interfaces for presenting digital media assets in a consistent and/or unified manner regardless of whether the digital media assets are located locally or remotely. Users are thus provided with information on those digital media assets that are available to users regardless of whether the digital media assets are located locally or remotely. As digital media assets become available or unavailable, presentations of the digital media assets can be automatically updated. For example, a presentation of digital media assets available to a media device for playback can be dynamically updated.

In one implementation, as a remote media storage device, such as a host computer (e.g., personal computer) providing media storage, becomes connected (wired or wirelessly) with a media device, additional digital media assets even though remotely stored can be available to the media device. However, if the remote media storage device is later disconnected from the media device, the additional digital media assets become unavailable to the media device. Transfer of digital media assets can also be optionally be performed between the remote media storage device and the media device. One type of transfer is referred to as synchronization, which can causes remotely located digital media assets to become locally resident.

In general, a media device as used herein is an electronic device that supports media presentation (e.g., media playback). A media device can, for example, correspond to one or more of: a set-top box, music player, game player, video player, camera, mobile telephone (e.g., cell phone), personal digital assistant (PDA), computer and/or the like. When the media device supports two or more such functions, the media device can be referred to as a multi-function device.

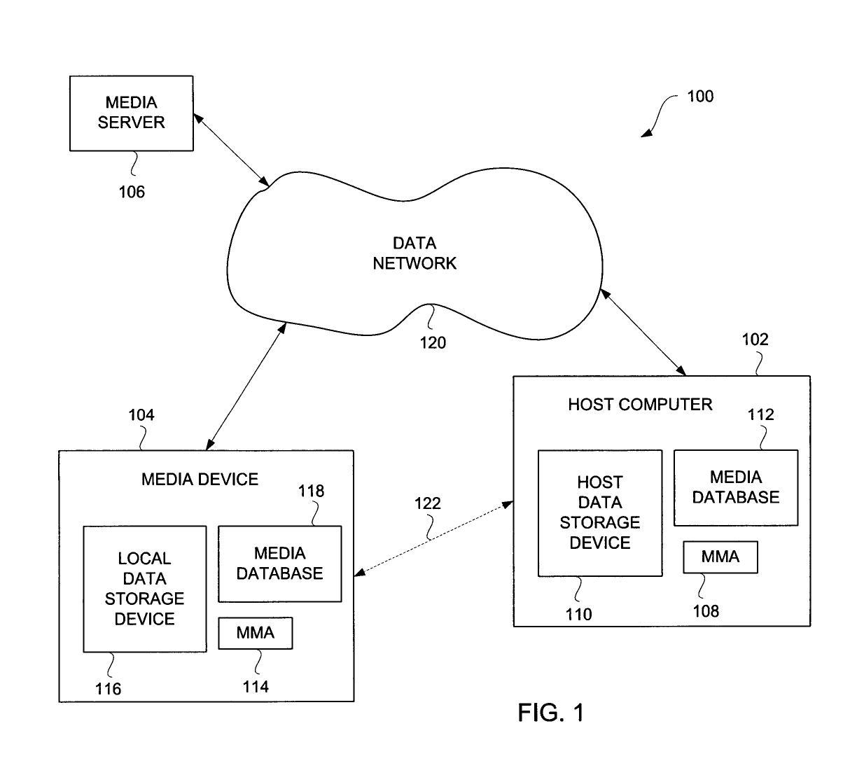

Embodiments of various aspects of the invention are discussed below with reference to FIGS. 1-7. However, those skilled in the art will readily appreciate that the detailed description given herein with respect to these figures is for explanatory purposes as the invention extends beyond these limited embodiments.

FIG. 1 is a block diagram of a media system 100 according to one embodiment of the invention. The media system 100 includes a host computer 102, a media device 104 and a media server 106. The host computer 102 includes a media management application (MMA) 108 that operates to manage the storage, search, browse, retrieval, playback, download or transfer of media assets on, to or from the host computer 102. The host computer 102 also includes a host data storage device 110 and a media database 112. The host data storage device 110 stores media data (digital data) in electronic files for media assets that are stored on the host computer 102. The media database 112 stores metadata pertaining to media assets stored on the host computer 102.

The media device 104 is, for example, a media presentation device. The media device 104 can also be referred to as a client device. The media device 104 includes a media management application (MMA) 114 that facilitates storage, search, browse, retrieval, playback, download or transfer of media assets with respect to the media device 104. The media device 104 also includes a local data storage device 116 and a media database 118. The local data storage device 116 stores media data pertaining to media data (digital data) in electronic files for media assets that are stored on the media device 104. The media database 118 stores metadata pertaining to media assets stored on or available to the media device 104. For example, if the host computer 102 is accessible by the media device 104, the media database 118 can include metadata pertaining to media assets stored on the media device 104. Additionally, the media database 118 can include metadata pertaining to media assets stored on the host computer 102, though such media assets are accessible to the media device only if the host computer 102 is active (i.e., “on”).

Within the media system 100, the host computer 102 as well as the media device 104 can allow users to select and playback media assets that are stored on such devices. In one embodiment, the host computer 102 can receive media assets from the media server 106 via a data network 120. The media server 106 can host an on-line media store that provides search, browse, purchase and download of media assets. When the host computer 102 interacts with the media server 106 to download a media asset, the media asset can be managed by the media management application 108, including storage of the media asset to the host data storage device 110 and storage of associated metadata in the media database 112. A media asset that is stored on the host computer 102 can also be copied (or transferred) to the media device 104. Such copying can be part of a synchronization process between the two devices. In one implementation, data being copied for the media asset can be transmitted from the host computer 102 to the media device 104 via the data network 120. In another implementation, data for the media asset being copied can be transferred over a link 122 established between the host computer 102 and the media device 104. As an example, the host computer 102 and the media device 104 can include wireless interface circuitry that allows that host computer 102 and the media device 104 to communicate in a wireless manner over the link 122. As an example, the wireless link 122 could pertain to a piconet, such as a Bluetooth network or other short range network.

A user of the host computer 102 can select and play back a media asset stored within the host data storage device 110 through use of the media management application 108. Typically, the host computer 102 will include or couple to a display device whereby the playback of the media asset can provide visual media output (e.g., display device) and/or audio media output (e.g., a speaker). The display device can also support a graphical user interface that provides menus, user interface (UI) controls, etc. that assist a user in interacting with the host computer 102 while selecting and playing media assets. In one embodiment, a user can be presented with a list of media assets available for playback at the media device 104. The list of media assets that are available can include media assets available locally at the media device 104 and/or media assets available remotely (e.g., from the host computer 102, if the host computer 102 is active and connected to the media device 104). If the media data is locally available, the playback of a media asset on the media device 104 can retrieve data for the media asset from the local data storage device 116 and output audio and/or video media output. If the media data is not available locally available but available remotely, the playback of a media asset on the media device 104 can stream data for the media asset from the host data storage device 110, thereby providing audio and/or video media output.

In one embodiment, the host computer 102 and the media device 104 can interact to copy media assets therebetween. For example, the media device 104 can synchronize its stored media assets with those stored media assets at the host computer 102. In one implementation, the media device 104 has less available data storage capacity in the local data storage device 116 than does the host data storage device 110. Hence, in such an embodiment, preferences, namely, synchronization preferences, can be utilized to intelligently determine which media assets from the host data storage device 110 should be copied to the local data storage device 116.

In one embodiment, the media device 104 may be occupied performing various operations when synchronization with the host computer 102 is available. In one embodiment, the copying of media assets from the host computer 102 to the media device 104 can be performed at a lower priority than the other operations, such as media playback, on the media device 104. Hence, if the media device 104, namely the media management application 114, is operating to playback one or more media assets, any copying of media assets from the host computer 102 to the media device 104 can be temporarily suspended while the playback is being performed at the media device 104.

Still further, in one embodiment, the media device 104, by way of the media database 118, knows the media assets that are determined to be copied from the host computer 102 to the media device 104. However, since the media assets are rather large in size and the media device 104 may be busy performing other tasks, media data may not have been received at the local data storage device 116 when a user desires to playback the associated media asset. In such case, the media database 118 may have already stored the metadata pertaining the media asset, such that the media management application 114 can enable a user to select the media asset for playback. Once a media asset is selected to be played back, the media device 104 can determine whether the media asset is stored in the local data storage device 116. If the media asset is not already stored to the local data storage device 116, the media management application (MMA) 114 can determine a remote location for the media data for the media asset through use of the media database 118. For example, the media database 118 can store an address location (e.g., address pointer) to a remote location accessible by the media device 104 by way of the data network 120 or the link 122. The media management application 114 can then access the remote location to retrieve the media asset and have it delivered to the media device 104 so that the media asset is able to be played on the media device 104. In one implementation, the media management application 114 accesses the host computer 102 over the link 122 to open a streaming connection such that the media data pertaining to the selected media asset can be streamed from the host computer 102 to the media device 104 where it is to be played back.

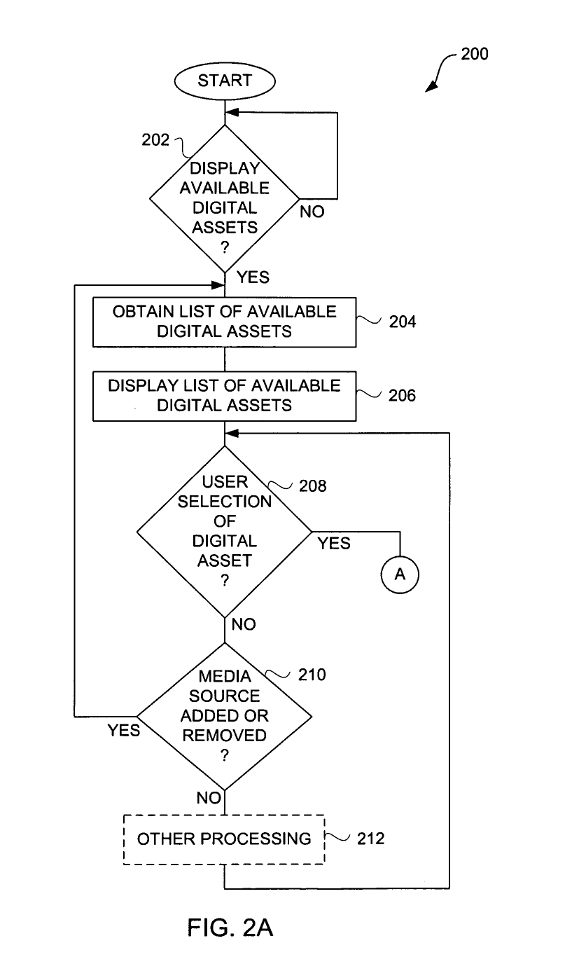

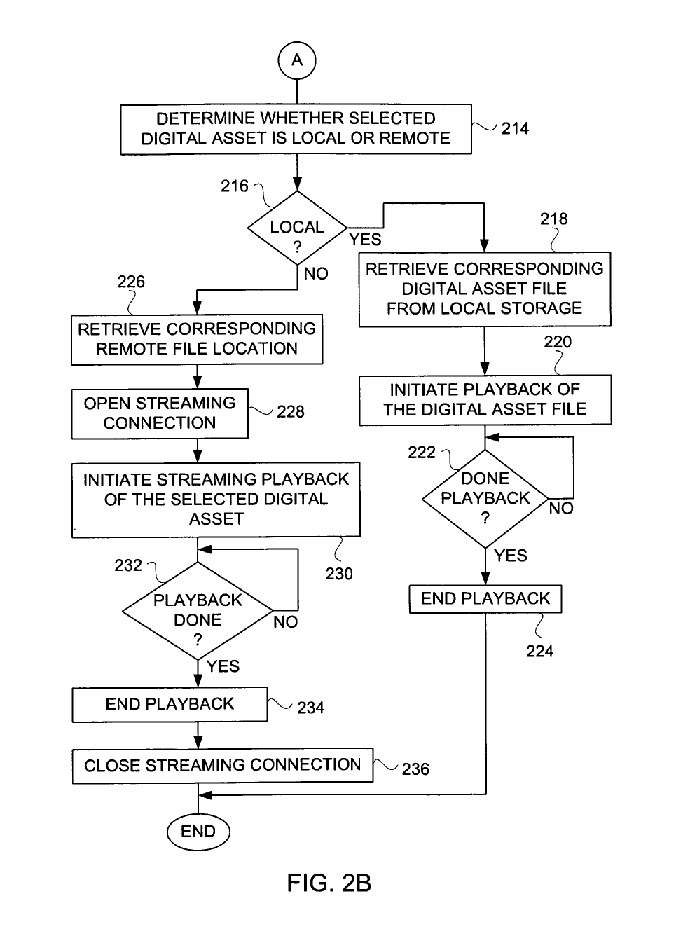

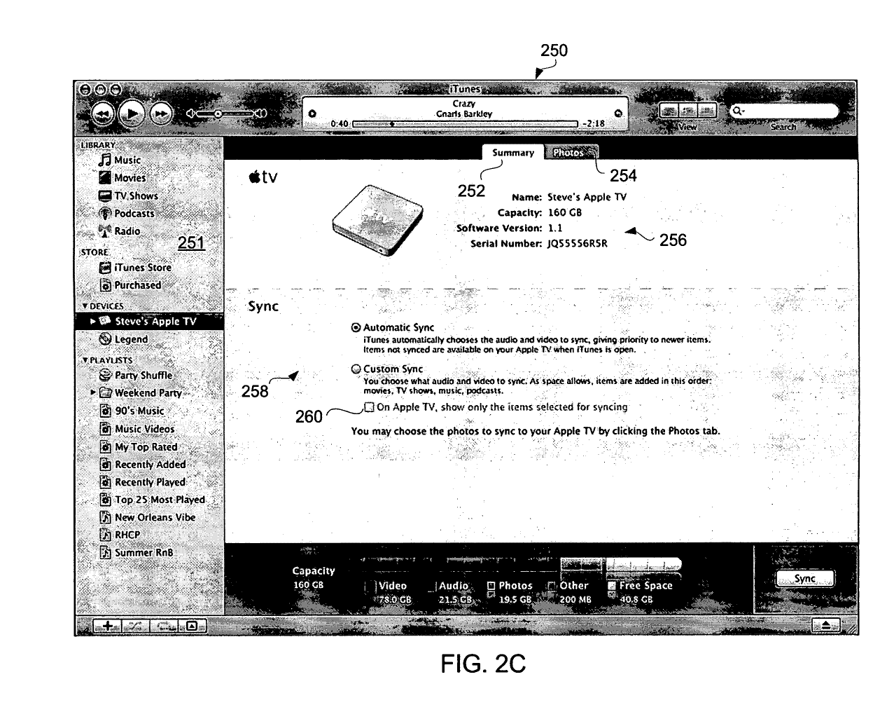

FIGS. 2A and 2B are flow diagrams of a digital asset presentation and playback process 200 according to one embodiment of the invention. The digital asset presentation and playback process 200 is, for example, performed by a media device that is capable of storing media items and also playing back media items. For example, the digital asset presentation and playback process 200 can be performed by the media device 104 illustrated in FIG. 1.

The digital asset presentation and playback process 200 can begin with a decision 202 that determines whether available digital assets are to be displayed. When the decision 202 determines that available digital assets are not to be displayed, the digital asset presentation and playback process 200 awaits the need to display available digital assets. In other words, the digital asset presentation and playback process 208 is performed or invoked when available digital assets are to be displayed for playback or other purposes.

Once the decision 202 determines that available digital assets are to be displayed, a list of available digital assets can be obtained 204. In one implementation, the media device can access a media database associated with the media device to identify the digital assets that are available to the media device. These available digital assets can be provided or arranged in a list which is suitable for display. The list of available digital assets can then be displayed 206. Typically, the media device has a display device that is integrated with or coupled to the media device. In such an embodiment, the list of available digital assets can be displayed 206 on the display device.

Next, a decision 208 determines whether a user selection of one of the available digital assets has been received. Here, after the list of available digital assets is displayed 206, at least one of the available digital assets within the list can be selected to initiate another action, such as playback. Hence, the decision 208 can determine whether a user has selected one of the available digital assets in the list of available digital assets being displayed 206. When the decision 208 determines that a user selection of an available digital asset has not been made, a decision 210 can determine whether a media source has been added or removed from the media device. For example, a media source can be coupled to the media device by way of a network, whether wired or wireless. Hence, upon connection of the media device to the media source, the media source is added to (or coupled to) the media device. Alternatively, upon disconnection of a media source from the media device, the media source can be effectively removed from the media device. When the decision 210 determines that a media source has been added or removed, then the digital asset presentation and playback process 200 can return to repeat the block 204 so that the list of available digital assets can be automatically (e.g., dynamically) updated in view of the added or removed media source.

On the other hand, when the decision 210 determines that a media source has not been added or removed, other processing 212 can optionally be performed. The other processing 212 can depend on user interaction with the media device and/or the nature of the media device itself. Following the block 212, the digital asset presentation and playback process 200 can return to repeat the decision 208 so that user selections of digital assets can be processed.

Once the decision 208 determines that a user has selected one or more of the digital assets in the list of available digital assets being displayed 206, the digital asset presentation and playback process 200 can determine 214 whether the selected digital asset is local or remote. Here, the determination 214 determines whether the selected digital asset is stored locally at the media device or stored remotely from a host device. For example, the host device can pertain to the host computer 102 illustrated in FIG. 1. In one implementation, the determination 214 can be performed by accessing a media database, such as the media database 118 illustrated in FIG. 1.

A decision 216 can then determine whether the selected digital asset is stored locally at the media device. When the decision 216 determines that the selected digital asset is stored locally at the media device, a corresponding digital asset file can be retrieved 218 from local storage. For example, if the media device is the media device 104 illustrated in FIG. 1, the local storage can pertain to the local data storage device 116. Playback of the digital asset file can then be initiated 220. Next, a decision 222 can determine whether playback of the digital asset file has completed. When the decision 222 determines that playback of the digital asset file has not completed, then the decision 222 can wait until playback of the digital asset file has completed. Once the decision 222 determines that playback of the digital asset file has completed, then the playback of the digital asset file can end 224.

On the other hand, when the decision 216 determines that the selected digital asset is not available locally (but available remotely), a corresponding remote file location for the selected digital asset can be retrieved 226. In one embodiment, the remote file locations for the various digital assets in the list of available media assets can point to locations external to the media device 104, such as locations at the host computer 102 or the media server 106 illustrated in FIG. 1. Next, a streaming connection can be opened 228. Streaming playback of the selected digital asset can then be initiated 230. At this point, the selected digital asset is being played back for the user of the media device, even though the digital data (digital content) for the selected digital asset is being provided to the media device by way of a streaming connection with another electronic device, such as the host computer 102 illustrated in FIG. 1. A decision 232 can then determine whether the playback of the selected digital asset is done. When the decision 232 determines that the playback of the selected digital asset is not done, then the digital asset presentation and playback process 200 can await the completion of the playback of the selected digital asset. Once the decision 232 determines that the selected digital asset is not done, the digital asset presentation and playback process 200 can await completion of the selected digital asset. Once the decision 232 determines that playback of the selected digital asset is done, the playback of the selected digital asset can end 234. The streaming connection can then be closed 236. Following the blocks 224 and 236, the digital asset presentation and playback process 210 can end.

FIG. 2C is an exemplary preference setting screen 250 according to one embodiment of the invention. The exemplary preference setting screen 250 can, for example, be produced and display at the host computer 102. The exemplary preference setting screen 250 includes a summary tab 252 and a photos tab 254. A source region 251 indicates that a device, namely, a media device is selected. The selected device is denoted “Steve's Apple TV” and can correspond to the media device 104 illustrated in FIG. 1. Hence, the summary tab 252 and the photos tab 254 are settings that apply to the selected device.

On selection of the summary tab, such as shown in FIG. 2C, a summary setting presentation can be provided. The summary setting presentation includes media device information 256 and general synchronization preference settings 258. The media device information 256 includes such information as name, capacity, software version and serial number for a particular media device (e.g., “Steve's Apple TV”). The synchronization preference settings 258 allow a user to select either automatic synchronization or customized synchronization. The automatic synchronization requests that synchronization be performed with the media management application (MMA) 108 automatically choosing digital media assets to be copied from the host computer 102 to the media device 104. The customized synchronization allows the user to choose particular digital media assets, groups of digital media assets, or criteria to be used when choosing digital media assets to be copied from the host computer 102 to the media device 104. The synchronization preference settings 258 can also include a user interface control 260 that provides a preference setting to enable a user (of the host computer 102) to request that when presenting digital media assets at the media device 104 only show those that are stored on the media device (but may also include those digital media assets that will be stored on the media device following synchronization). Hence, the user interface control 260 can be used to disable the unified presentation of available digital media assets at a media device as discussed herein.

On selection of the photos tab 254 a photos preference setting presentation can be provided. Using the preference setting presentation, the user can designate photos, groups of photos and/or criteria to be used to guide synchronization. For additional details on setting preferences for synchronization of photos or other type of digital media assets, see e.g., U.S. application Ser. No. 11/679,082, filed Feb. 26, 2007, and entitled “DATA SYNCHRONIZATION WITH HOST DEVICE IN ACCORDANCE WITH SYNCHRONIZATION PREFERENCES,” which is hereby incorporated herein by reference.

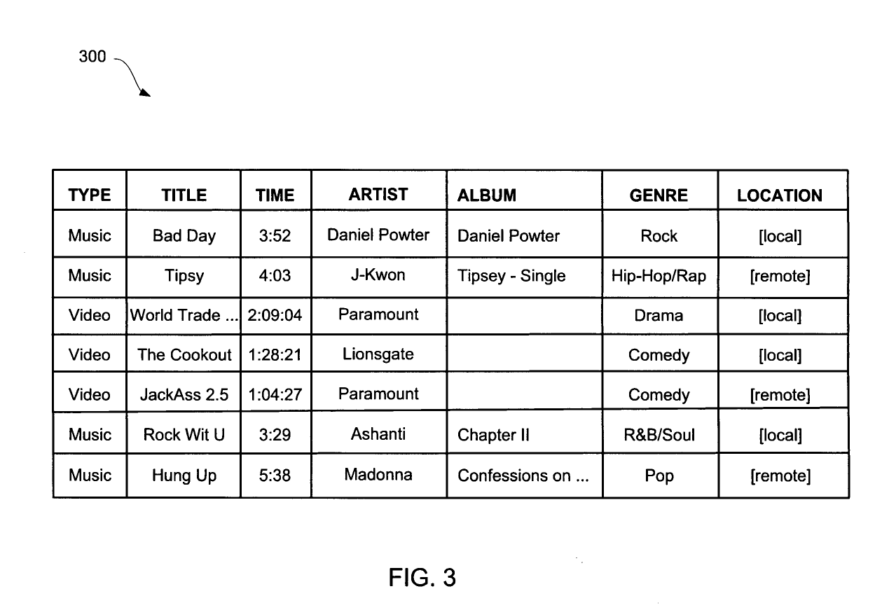

FIG. 3 is an exemplary representation of a media database 300 according to one embodiment of the invention. The media database 300 is, for example, suitable for use as the media database 118 illustrated in FIG. 1. The media database 300 serves to store data that can be used by a media device, such as the media device 104 illustrated in FIG. 1. The database 300 contains records for digital media assets which can be of different types, such as music or video. For each of the digital media assets, the corresponding database records can store metadata, such as title, time (duration), artist, album and/or genre. In addition, location information can be provided for each of the digital media assets. The location information can be a local asset location on the media device or a remote asset location on a remote device. In one implementation, the local asset location is a local file storage location, such as a file location within the local data storage device 116 of the media device 104 illustrated in FIG. 1. In one implementation, the remote asset location is a network resource address, such as a Universal Resource Locator (URL) to a remote device. For example, the remote device can pertain to the host computer 102 or the media server 106 illustrated in FIG. 1.

As shown in FIG. 3, the media database 300 specifies locations as being “[local]” or “[remote]”. A “[local]” location is a path to a particular file in a local file system. For example, “[local]” location can pertain to a pointer to a particular file stored in the local data storage device 116 of the media device 104. A “[remote]” location is a path to a particular file resident on a remote device. For example, “[remote]” location can pertain to a pointer to a particular file stored in the host data storage device 110 the host computer 102.

Assuming that the “[remote]” locations pertain to digital media assets resident on the host computer 102 and not resident on the media device 104, the media database 300 (and/or the media device 104) can represent a consolidated or unified view of available digital media assets that are available on not only the media device 104 but also the host computer 102. A connection (e.g., the link 122) between the host computer 102 and the media device 104 may not always be present. However, graphical user interfaces that present representations (e.g., lists) of available digital media assets can dynamically refresh to present only those of the digital media assets that are currently available. For example, if the host computer 102 is presently accessible to the media device 104, a graphical user interface can present a representation of each of the digital media assets listed in the media database 300. This representation can be a consolidated and/or unified presentation (e.g., list) of the available digital media assets. In one implementation, on presentation, there is no distinction made (visually or otherwise) as to whether the digital media assets being presented are available locally or remotely. In another implementation, on presentation, those of the digital media assets that are only remotely available can be visually distinguished from those of the digital media assets that are locally available. On the other hand, if the host computer 102 is presently not accessible to the media device 104, a graphical user interface can present a representation of only those of the digital media assets listed in the media database 300 that are resident (i.e., local to the media device 104).

The media database 300 facilitates a consolidated (or unified) view of digital media assets even though resident on different media storage devices. Further, as different media storages come and go, the media database 300 can be utilized such that graphical user interfaces can adapt (automatically or dynamically) to reflect digital media assets that are available from the media device.

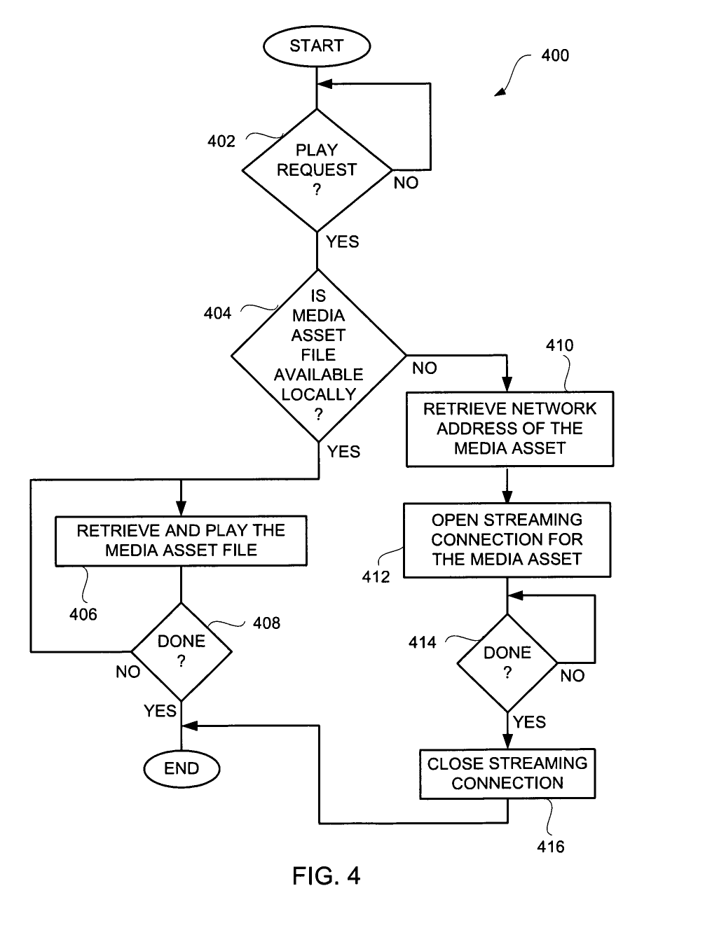

FIG. 4 is a flow diagram of a media asset playback process 400 according to one embodiment of the invention. The media asset playback process 400 is performed by a media device. For example, the media asset playback process 400 can be performed by the media device 104 illustrated in FIG. 1.

The media asset playback process 400 can begin with a decision 402. The decision 402 determines whether a play request has been received. Typically, a play request would be a request initiated by a user to play a particular media asset. When the decision 402 determines that play request has not been received, the media asset playback process 400 awaits such a request. In other words, the media asset playback process 400 is invoked when a play request is received.

Once the decision 402 determines that a play request has been received, a decision 404 can determine whether the media asset has a media asset file available locally at the media device. When the decision 404 determines that there is a media asset file available locally, the media asset file can be retrieved and played 406. A decision 408 can then determine whether the playback of the media asset file has completed. When the decision 408 determines that the playback has not completed, the media asset playback process 400 can return to repeat the block 406 until the playback completes. Once the playback completes, the media asset playback process 400 can end.

On the other hand, when the decision 404 determines that there is no media asset file available locally, a network address for the media asset can be retrieved 410. In one embodiment, the network address for the media asset is retrieved from a media database provided within the media device. After the network address has been retrieved 410, a streaming connection for the media asset can be opened 412 using the network address. Next, a decision 414 determines whether the streaming of the media asset has completed. When the decision 414 determines that the streaming of the media asset has not completed, the streaming continues. Once the decision 414 determines that the streaming has completed, the streaming connection can be closed 416 and the media asset playback process 400 can end.

In one embodiment, the media device utilized in accordance with the present invention can store a large number of media assets. These media assets can be of the same type or different type of media asset. For example, one type of media asset is audio files, such as music (songs), audiobooks or podcasts. Another type of media assets are images, such as photos. Still another type of media asset is video files, such as movies or music videos. The media device can include a data storage device (e.g., memory) that is able to store media assets that have been copied to the media device. However, media storage to the data storage device is limited at the media device. Hence, it is not always possible to store within the data storage device all of the media assets that are to be copied (e.g., from a host device) to the media device. As a result, in one embodiment of the invention, different priority levels can be used to prioritize which of the media assets should be stored to the media memory.

The transfer of media data (e.g., media assets) for a media device can be referred to as synchronization. Synchronization can be between a host device (e.g., host computer) and the media device. Media data from a host device (e.g., host computer) can be provided to and stored on the media device, and vice versa. Preference settings can be established at either the host device or the media device and utilized to control or influence the synchronization process. Additionally, it should be noted that there can also be an order of priority for the different types of media assets. The order of priority can affect synchronization if storage capacity at the device receiving the media assets is insufficient.

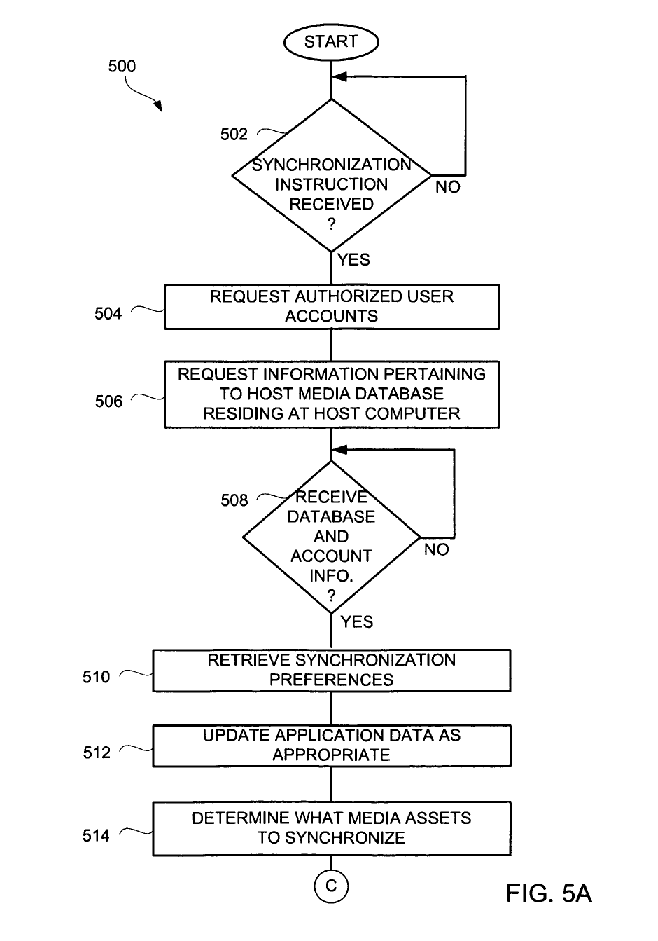

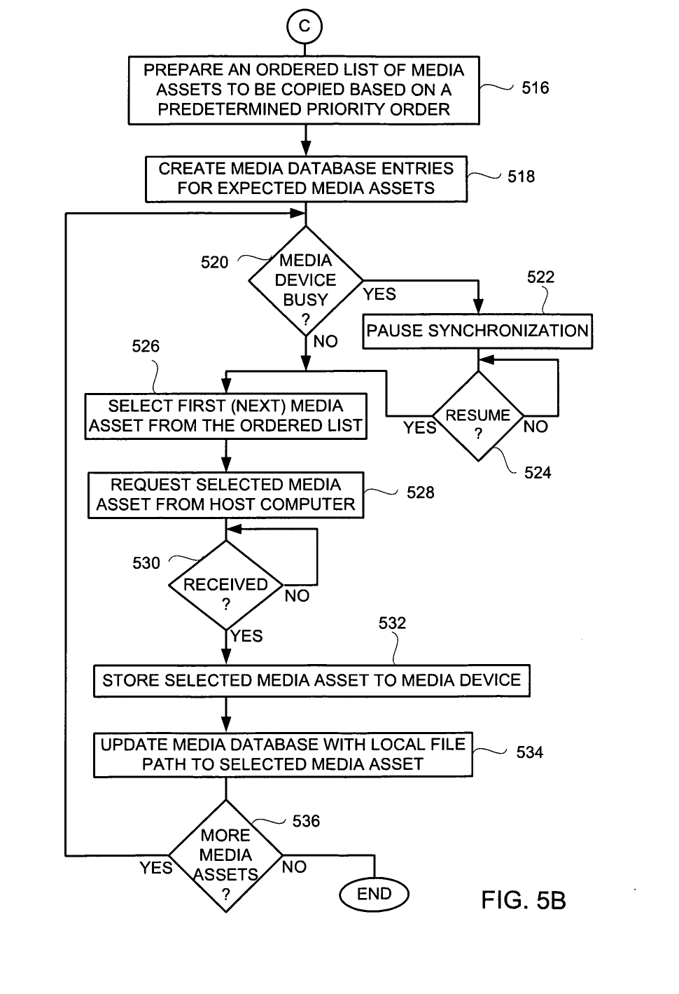

FIGS. 5A and 5B are flow diagrams of a synchronization process 500 according to one embodiment of the invention. The synchronization process 500 is, for example, performed by a media device. The media device is connected (in a wired or wireless manner) to a host device, such as a host computer. The synchronization process 500 operates to primarily copy media items and associated media information from the host device to the media device.

The synchronization process 500 can begin with a decision 502. The decision 502 determines whether a synchronization instruction has been received. In this embodiment, the synchronization process 500 is initiated by a synchronization instruction, such as a command, that is provided to the media device by the host device. When the decision 502 determines that a synchronization instruction has not been received, the synchronization process 500 awaits such an instruction. In other words, the synchronization process 500 can begin when a synchronization instruction has been received. Once the decision 502 determines that a synchronization instruction has been received, authorized user accounts can also be requested 504. In addition, information pertaining to a host media database residing on the host computer can be requested 506.

A decision 508 then determines whether database and account information as requested have been received. When the decision 508 determines that the requested database and account information have not yet been received, the synchronization process 500 awaits such information. On the other hand, when the decision 508 determines that database and account information have been received, synchronization preferences are retrieved 510. Typically, the synchronization preferences are those preferences that have been configured specifically for the media device or for a type of device corresponding to the media device. In one embodiment, the synchronization preferences were previously configured at the host computer. In another embodiment, the synchronization preferences were previously configured at the media device. In still another embodiment, the synchronization preferences were previously configured at the media device and at the host computer. Application data, such as data pertaining to a media-based application operating on at least the media device can be updated 512 as appropriate. Application data can correspond to parameters, values, etc. used or monitored by an application program. Examples of application data for a media playback application are play counts or ratings corresponding to media assets. Application data can be maintained at both the media device and the host computer. Hence, the update 512 to the application data can be associated with application data at either the media device or the host computer. In such cases, the application data being updated 512 can be provided in either direction from one of the devices to another. In any case, after the synchronization preferences have been retrieved 510, the synchronization process 500 determines 514 what media assets to synchronize.

After the media assets to be synchronized have been determined 512, an ordered list of media assets to be copied can be prepared 516 based on a predetermined priority order. Further, media database entries are created 518 for expected media assets. That is, for each of the media assets within the ordered list that is to be copied to the media device, the media database residing in the media device can be modified to create 518 database entries for each of the expected media assets to be copied to the media device. These media database entries can initially contain metadata information as well as a network address to a corresponding media asset file.

Next, a decision 520 determines whether a media device is busy. When the decision 520 determines that media device is busy, synchronization can be paused 522. For example, the media devices may be performing other tasks that are to be performed promptly. In such cases, synchronization can be deferred. Next, a decision 524 determines whether synchronization should resume. When the decision 524 determines that synchronization should not resume, the synchronization process 500 waits to resume. Once the decision 524 determines that the synchronization process should resume, the synchronization process 500 continues. Likewise, wherein the decision 520 determines that the media device is not busy, the synchronization process 500 continues.

When the synchronization process 500 continues, a first media asset from the ordered list can be selected 526. Then, the selected media asset is requested 528 from the host computer. Next, a decision 530 determines whether the selected media asset being requested has been received. When the decision 530 determines that the selected media asset has not yet been received, the synchronization process 500 can await its receipt. Alternatively, once the decision 530 determines that the selected media asset has been received, the selected media asset is stored 532 to the media device. In one embodiment, the selected media asset being stored 532 includes metadata and the storage 532 of the selected media asset also serves to update or store such metadata. In addition, the media database can be updated 534 to specify a local file path for the selected media asset. The local file path is a file path associated with the file system within the media device. In other words, the selected media asset is now stored locally within the media device and the media database contains a pointer directed it local storage location.

Next, a decision 536 determines whether there are more media assets to be processed. When the decision 536 determines that there are more media assets to be processed, the synchronization process 500 can return to repeat the decision 520 and subsequent blocks. At block 526, a next media asset is selected from the order list and similarly processed. Alternatively, when the decision 536 determines that there are no more media assets to be processed, the synchronization process 500 can end.

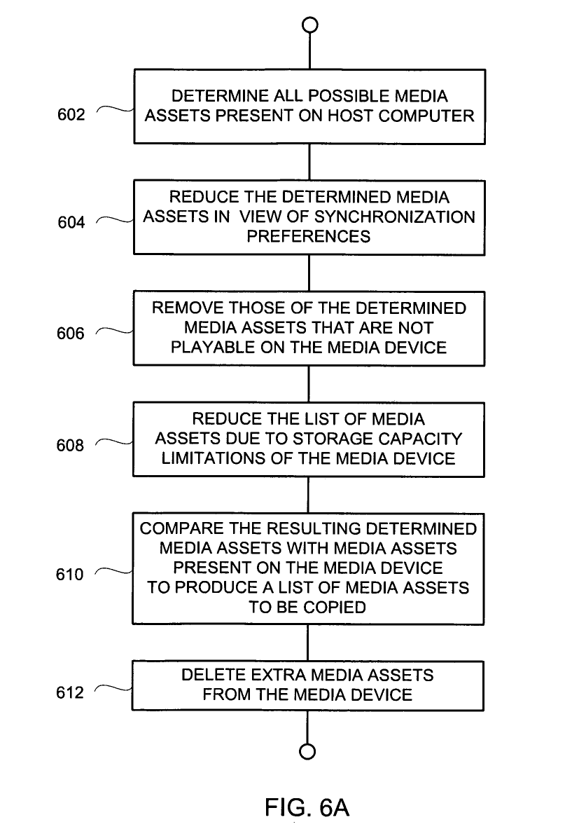

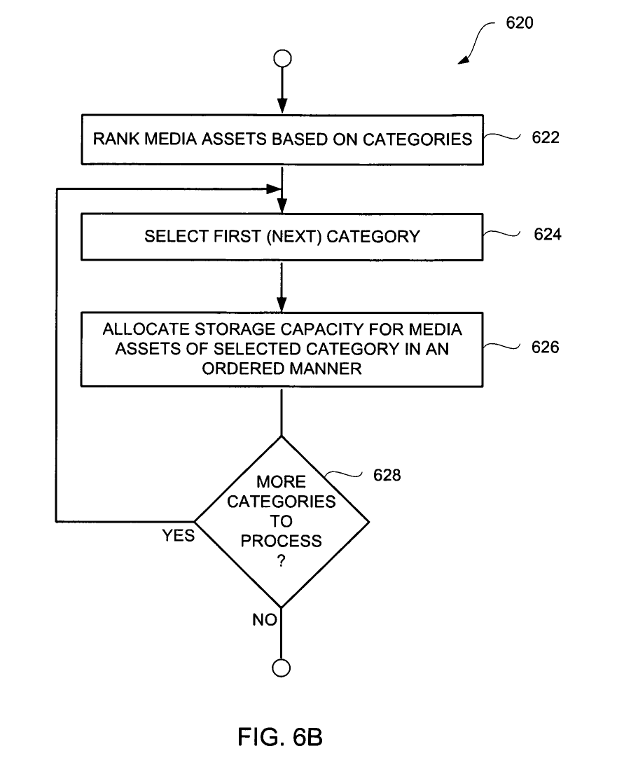

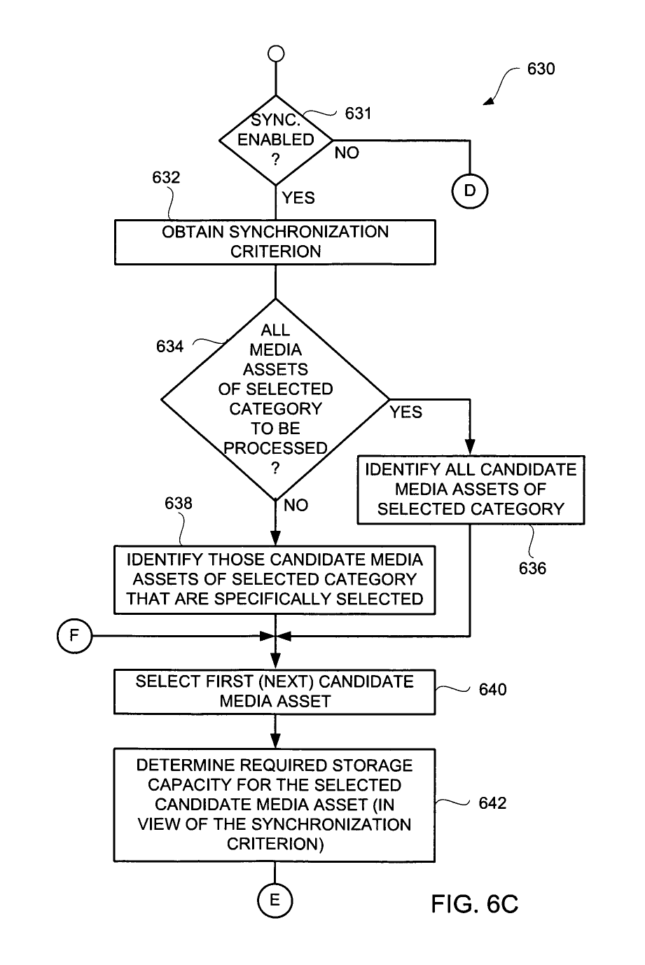

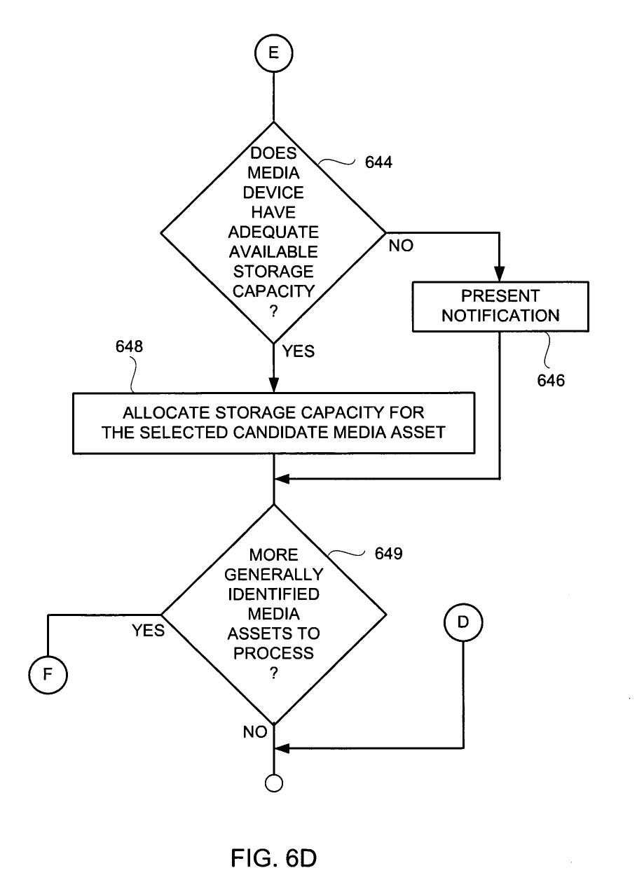

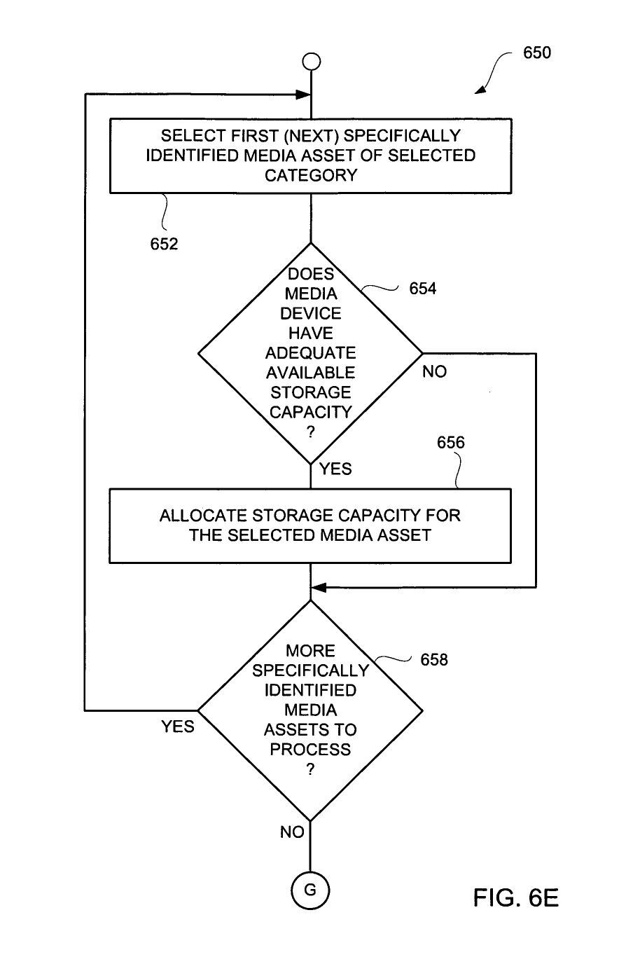

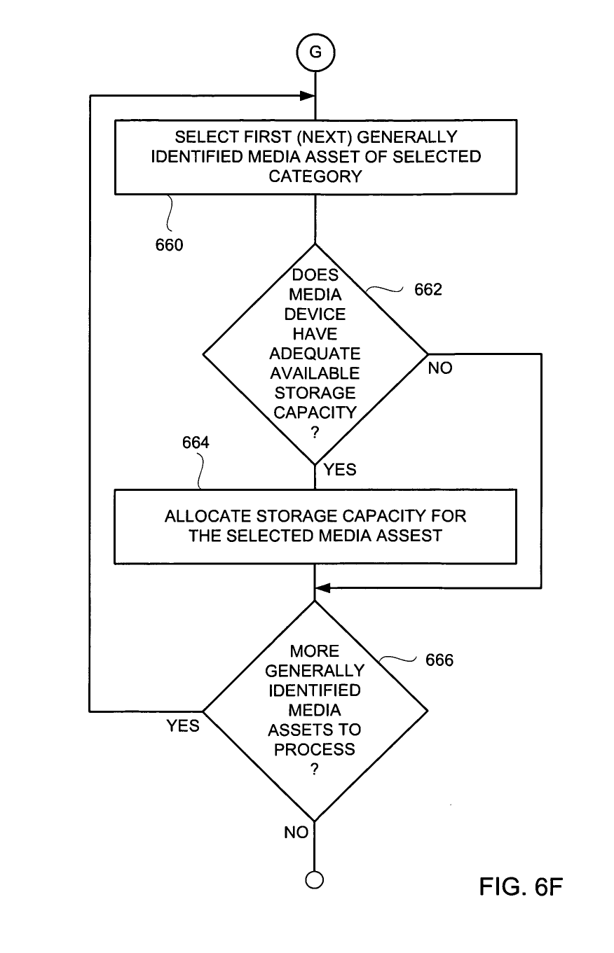

FIG. 6A is a flow diagram of a media asset determination process 600 according to one embodiment of the invention. The media asset determination process 600 is, for example, processing associated with the block 514 illustrated in FIG. 5A.

The media asset determination process 600 can initially determine 602 all possible media assets present on the host computer. Next, the determined media assets can be reduced 604 in view of the synchronization preferences. For example, the determined media assets may include a plurality of different types of media assets. The synchronization preferences can, for example, exclude certain types, classes or groups of media assets from being included in a synchronization process. Hence, the determined media assets can be reduced 604 in many cases in view of the synchronization preferences. Next, those of the determined media assets that are not playable on the media device can be removed 606. Often, the media device supports only a limited number of media formats for playback. Hence, in the case in which some of the determined media assets are not compatible with the playback capabilities of the media device, such media assets can be removed from the determined media assets.

Furthermore, in one embodiment, the list of media assets can be reduced 608 due to storage capacity limitations of the media device. Hence, in the event that the total storage capacity required by the resulting determined media assets is greater than the available storage capacity of the media device, the resulting determined media assets remaining on the list of media assets can be reduced 608. In one embodiment, the manner by which the media assets are reduced 608 can be in accordance with a priority order based on the type of media asset. The priority order can be pre-set and/or user-determined. In one implementation, movies are given the highest priority, then TV shows, then music, then broadcast, and then photos.

The resulting determined media assets can be compared 610 with media assets present on the media device to produce a list of media assets to be copied. Optionally, the media asset determination process 600 can delete 612 extra media assets from the media device. For example, prior to copying the resulting determined media assets to the media device, the media device could delete those media assets already on the media device that are no longer needed on the media device or are no longer present on the host computer. One advantage of deleting certain previously stored media assets from the media device is to free up additional storage capacity for purposes of storing the resulting determined media assets to the media device.

Another embodiment of the invention pertains to prioritization of media assets before being copied from one electronic device to another electronic device. A recipient electronic device typically is provided with data storage that has a deterministic limit. Hence, when copying files to the second electronic device, the amount of media data being copied cannot exceed the storage capacity of the second electronic device. Accordingly, prioritization of the media assets prior to their being copied operates to arrange the media assets in a priority order. Thereafter, upon copying of the media assets to the second electronic device, they can be copied in the established priority order. To the extent that the amount of media data to be copied exceeds the memory capacity of the second electronic device, the remaining media assets of lower priority are not copied to the second electronic device which at that point has no adequate available storage capacity for such media assets.

In one embodiment, the media assets can first be prioritized according to categories. Exemplary categories include movies, TV shows, music (including music videos), podcasts, and photos. In one implementation, the prioritization can be in the order in which the categories are listed. This ordering can be referred to as a default or preset priority order. In another implementation, a user is permitted to re-order the categories to insert a different prioritization. As one example, the categories can be presented on a display in their default priority order, and then a user can, for example, manipulate one or more user interface controls to alter the priority order of the categories. For example, the user interface controls can refer to tabs in one example. In addition, within each category, there can be a prioritization of the media assets. For movies, movies that are specifically selected by a user via a graphical user interface can be copied at a higher priority and can be copied in a sort order (e.g., order listed on a display device). Other movies that are selected by a general grouping (e.g., recently watched movies) can also be copied but at a lower priority. For TV shows, media assets can be prioritized in their sort order (i.e., in the order listed on the display). Episodes pertaining to a particular TV show can in turn be prioritized from most recent episode to least recent episode. For music, media assets (in particular songs) can be prioritized in the order of the playlist in which the songs are contained, with the playlists being prioritized in their sort order (e.g., as displayed on a display). If all songs are selected to be copied, then those songs contained in one or more playlists are given a higher priority than songs that are only contained in the library. Podcasts can be prioritized in their sort order (e.g., as displayed on the display). Episodes pertaining to a single podcast (i.e., RSS feed) can be prioritized from most recent episode to least recent episode. For photos, photo albums can be prioritized according to their order as being displayed. In one implementation, only complete albums are copied. Hence, in the case in which there is inadequate data storage capacity to copy a complete album, then according to one implementation none of the photos pertaining to the album would be copied.

FIG. 6B is a flow diagram of a media asset prioritization process 620 according to one embodiment of the invention. The media asset prioritization process 620 is, for example, processing associated with the block 516 illustrated in FIG. 5B.

The media asset prioritization process 620 can begin with ranking 622 media assets based on categories. Typically, the media assets would be associated with different categories. The categories can have a priority order that is preset or user-determined. For example, in one embodiment, synchronization preferences can be altered by a user to adjust the priority order of the categories. More generally, a category can pertain to a data type. Examples of categories (or data types) include movies, music, television (TV) shows, podcasts, photos, contacts, electronic mail, contacts, calendars, and web browser bookmarks.

After the media assets have been ranked 622, a first category is selected 624 to be processed. Next, storage capacity (associated with the recipient electronic device) is allocated 626 for media assets of the selected category in an ordered manner. For example, if the selected category includes ten different media assets arranged in a priority order, storage capacity for the ten different media assets can be allocated in the priority order. In the event that all ten of the media assets fit within the recipient electronic device, then the allocated 626 storage capacity pertains to the combined total size of the ten media assets. In the event that the storage capacity required by the media assets of the selected category exceeds the available storage capacity then those of the media assets that can be stored to the recipient electronic device can be allocated storage capacity, with one or more of the media assets deemed unable to be copied to the recipient electronic device.

Next, a decision 628 determines whether there are more categories to be processed. When the decision 628 determines that there are more categories to process, the media asset prioritization process 620 can return to repeat the block 624 so that a next category can be selected and then storage capacity allocated 626. Optionally, if the storage capacity for the recipient electronic device has already been completely allocated 626, the decision 628 can determine that no additional categories are to be processed. In any event, when the decision 628 determines that there are no more categories to be processed, the media asset prioritization process 620 can end. At this point, the media assets available to be copied to the recipient electronic device have been limited, as appropriate, to the storage capacity limitation of the recipient electronic device.

There are various different implementations or embodiments that can be utilized to allocate storage capacity for media assets that are to be copied. Different types (or categories) of media assets can be processed differently if so desired. Rules or policies can also be used to determine how to process the different types (or categories) of media assets.

FIGS. 6C and 6D illustrate a first category synchronization process 630 according to one embodiment of the invention. The first category synchronization process 630 is, for example, processing associated with the block 626 illustrated in FIG. 6B.

The first category synchronization process 630 begins with a decision 631. The decision 631 determines whether synchronization is enabled. Here, the first category synchronization process 630 pertains to synchronization of those media assets within a particular category. The decision 631 can determine whether synchronization, which is a form of copying, has been enabled for the particular category. When the decision 631 determines that synchronization for the particular category has not been enabled (i.e., disabled) then the first category synchronization process 630 skips all synchronization processing for this category and ends. On the other hand, when the decision 631 determines that synchronization is enabled for the selected category, synchronization criterion can be obtained 632. The synchronization criterion can pertain to a user selection of criterion or criteria that are used to distinguish media assets within the selected category.

A decision 634 can then determine whether all media assets of the selected category are to be processed. In this embodiment, the first category synchronization process 630 allows a user to specify whether they would like all media assets of the selected category to be processed or, alternatively, only like those specifically identified media assets of the selected category to be processed. When the decision 634 determines that all media assets of the selected category are to be processed, then all candidate media assets of the selected category can be identified 636. On the other hand, when the decision 634 determines that not all of the media assets of the selected category are to be processed, then those candidate media assets of the selected category that have been specifically selected can be identified 638. At this point, the candidate media assets to be copied (or synchronized) have been identified and are in an ordered list. The ordered list of media assets can then be processed as follows.

A first candidate media asset is selected 640. Then, the required storage capacity for the selected candidate media assets can be determined 642. In one embodiment, the selected candidate media asset pertains to a set or family of one or more episodes of the selected candidate media asset. In such case, the synchronization criterion previously obtained 632 can be used to designate those of the episodes to be copied, which in some cases limits the quantity of episodes to be copied. A decision 644 then determines whether the media device has adequate available storage capacity. When the decision 644 determines that the media device does not have adequate available storage capacity for the selected candidate media asset, then a notification can be presented 646. For example, the notification can be a visual notification or an audio notification presented to the user of the first electronic device. The notification can, for example, inform the user that the media assets of the particular category being processed are not able to be completely stored to the second electronic device. The notification can also indicate to the user where the synchronization process has ended.

On the other hand, when the decision 644 determines that the media device does have adequate available storage capacity, storage capacity for the selected candidate media asset is allocated 648. In the case in which the selected candidate media asset pertains to a set or family of media assets, such as episodes, the episodes can be processed in a priority order as well. For example, if all of the episodes designated to be copied are able to be copied, then the storage capacity is allocated 648 for all of the episodes. When the storage capacity is unable to store all of the designated episodes, then according to one embodiment the episodes designated to be copied can be copied in priority order until the storage capacity has been completely allocated.

Following the blocks 646 and 648, a decision 649 determines whether more candidate media assets are to be processed. When the decision 649 determines that there are more candidate media assets to be processed within the particular category, the first category synchronization process 630 returns to repeat the decision 640 and subsequent blocks so that a next candidate media asset can be selected and similarly processed. Once the decision 649 determines that there are no more media candidate assets to be processed (or when the storage capacity of the second electronic device has already been completely allocated), the first category synchronization process 630 can end.

FIGS. 6E and 6F illustrate a flow diagram of a second category synchronization process 650 according to one embodiment of the invention. The second category synchronization process 650 is, for example, processing associated with the block 626 illustrated in FIG. 6B. In this embodiment, the media assets to be synchronized for a given category can be specifically identified or generally identified. Typically, a user can set, alter or modify synchronization preferences that can determine those media assets being specifically identified and those being generally identified. In this embodiment, within a given category, specifically identified media assets are treated with higher priority than generally identified media assets.

The second category synchronization process 650 can select 652 a first specifically identified media asset of the selected category. A decision 654 can determine whether the media device (e.g., recipient electronic device) has adequate available storage capacity for the selected media asset. When the decision 654 determines that the media device does have adequate available storage capacity, storage capacity for the selected media asset can be allocated 656. Alternatively, when the decision 654 determines that the media device does not have adequate available storage capacity, the block 656 is bypassed and no storage capacity is allocated for the selected media asset. Following the block 656, or it being bypassed, a decision 658 can determine whether there are more specifically identified media assets to be processed. When the decision 658 determines that there are more specifically identified media assets to be processed, the second category synchronization process 650 can return to repeat the block 652 so that a next specifically identified media asset of the selected category can be selected 652 and similarly processed.

On the other hand, once the decision 658 determines that there are no more specifically identified media assets to be processed, a first generally identified media asset of the selected category can be selected 660. A decision 662 can determine whether the media device has adequate available storage capacity for the selected media asset. When the decision 662 determines that the media device does have adequate available storage capacity for the selected media asset, then storage capacity for the selected media asset can be allocated 664. Alternatively, when the decision 662 determines that the media device does not have adequate available storage capacity, the block 664 is bypassed and no storage capacity is allocated for the selected media asset. Following the block 664, or its being bypassed, a decision 666 can determine whether there are more generally identified media assets to be processed. When the decision 666 determines that there are more generally identified media assets to be processed, the second category synchronization process 650 can return to repeat the block 660 so that a next generally identified media asset of the selected category can be selected and similarly processed. Once the decision 666 determines that there are no more generally identified media assets to be processed, the second category synchronization process 650 can end.

Media assets being synchronized between a host computer and a client device are often large electronic files that take some time to copy between devices. Hence, in one embodiment, the copying of media assets for synchronization can be performed at a lower priority than other functions carried out by a client device. For example, a client device (e.g., media device) can be consuming much of its processing resources in playing a media asset or acquiring a media asset from an online media store. Thus, synchronization can be managed so as to not interfere with other potentially more important tasks of the client device.

Embodiments of the invention can be well suited for electronic devices having media playback capabilities, such as set-top boxes, digital video recorders or computers that are normally stationary, or portable media devices that are normally portable. These electronic devices can often store and play digital media assets (media items), such as music (e.g., songs), videos (e.g., movies), audiobooks, podcasts, meeting recordings, and/or other multimedia recordings. Portable media devices can, for example, be portable digital media players (e.g., MP3 players) or other portable multi-function devices (e.g., mobile telephones or Personal Digital Assistants). Portable media devices, such as portable media players or other portable multi-function devices, can also be small and highly portable and have limited processing resources. Often, portable devices are hand-held devices, such as hand-held media players or hand-held multi-function devices, which can be easily held by and within a single hand of a user. Portable devices can also be pocket-sized, miniaturized or wearable.

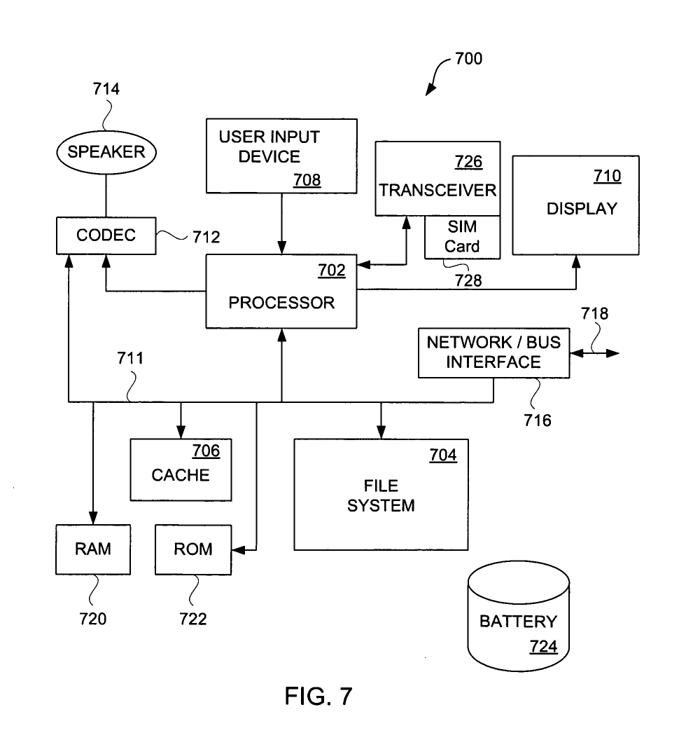

FIG. 7 is a block diagram of a mobile multi-function device 700 according to one embodiment of the invention. The mobile multi-function device 700 can, for example, include the circuitry of one or more of the media devices illustrated in FIG. 1A or the media device 70 illustrated in FIG. 1B. The mobile multi-function device 700 includes hardware and software components to provide at least two functions, namely, a media playback function and a wireless voice communications function. When providing media playback, the mobile multi-function device 700 can operate as a media player capable of playing (including displaying) media items. The media items can, for example, pertain to audio items (e.g., audio files or songs), videos (e.g., movies) or images (e.g., photos). When providing wireless voice communications, the mobile multi-function device 700 can operates a mobile telephone (e.g., cellular phone).

The mobile multi-function device 700 includes a processor 702 that pertains to a microprocessor or controller for controlling the overall operation of the mobile multi-function device 700. The mobile multi-function device 700 stores media data pertaining to media items in a file system 704 and a cache 706. In one embodiment, the file system 704 is implemented by a storage disk or a plurality of disks. In another embodiment, the file system 704 is implemented by EEPROM or Flash type memory. The file system 704 typically provides high capacity storage capability for the mobile multi-function device 700. However, since the access time to the file system 704 is relatively slow, the mobile multi-function device 700 can also include a cache 706. The cache 706 is, for example, Random-Access Memory (RAM) provided by semiconductor memory. The relative access time to the cache 706 is substantially shorter than for the file system 704. However, the cache 706 does not have the large storage capacity of the file system 704. Further, the file system 704, when active, consumes more power than does the cache 706. The power consumption is often a concern when the mobile multi-function device 700 is a portable mobile multi-function device that is powered by a battery (not shown). The mobile multi-function device 700 also includes a RAM 720 and a Read-Only Memory (ROM) 722. The ROM 722 can store programs, utilities or processes to be executed in a non-volatile manner. The ROM 722 can be implemented by an EEPROM or Flash type memory so as to provide writable non-volatile data storage. The RAM 720 provides volatile data storage, such as for the cache 706.

To support wireless voice communications, the mobile multi-function device 700 includes a transceiver 726. The transceiver 726 supports wireless communication with a wireless network (such as a wireless cellular network). To support certain wireless networks, such as a GSM network, the multi-function device 700 can also include a SIM card 728. The SIM card 728 includes an identifier (e.g., SIM identifier) can be used by the mobile multi-function device 700 to gain access and utilize the wireless network.

The mobile multi-function device 700 also includes a user input device 708 that allows a user of the mobile multi-function device 700 to interact with the mobile multi-function device 700. For example, the user input device 708 can take a variety of forms, such as a button, keypad, dial, etc. Still further, the mobile multi-function device 700 includes a display 710 (screen display) that can be controlled by the processor 702 to display information to the user. A data bus 711 can facilitate data transfer between at least the file system 704, the cache 706, the processor 702, and the CODEC 712.

In one embodiment, the mobile multi-function device 700 serves to store a plurality of media items (e.g., songs) in the file system 704. When a user desires to have the mobile multi-function device play a particular media item, a list of available media items is displayed on the display 710. Then, using the user input device 708, a user can select one of the available media items. The processor 702, upon receiving a selection of a particular media item, supplies the media data (e.g., audio file) for the particular media item to a coder/decoder (CODEC) 712. The CODEC 712 then produces analog output signals for a speaker 714. The speaker 714 can be a speaker internal to the mobile multi-function device 700 or external to the mobile multi-function device 700. For example, headphones or earphones that connect to the mobile multi-function device 700 would be considered an external speaker.

The mobile multi-function device 700 also includes a bus interface 716 that couples to a data link 718. The data link 718 allows the mobile multi-function device 700 to couple to a host device (e.g., host computer or power source). The data link 718 can also provide power to the mobile multi-function device 700.

The mobile multi-function device 700 illustrated in FIG. 7 represents only one embodiment of a mobile device suitable for use with the invention. Other embodiments can be significantly different. For example, other embodiments need not provide a wireless voice communications function. For example, the client device 1304 illustrated in FIG. 13 is typically a media device that primarily provides storage and playback of media assets. The client device 1304 can also support network access, such that media assets can be acquired from an online media store. However, the client device 1304 could be implemented by a device similar to the multi-function device 700 illustrated in FIG. 7, though the device would support local wireless data communications with the transceiver 726 and no SIM card 728 would be needed. Also, the display could be separately provided from the client device 1304.

The various aspects, embodiments, implementations or features of the invention can be used separately or in any combination.

Media assets can pertain to audio (e.g., songs, audio books, podcasts), videos (e.g., movies, music videos) or images (e.g., photos), as different types of media assets. Media assets also includes any combinations of these different type of media assets with other data.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

U.S. application Ser. No. 11/679,091, filed Feb. 26, 2007, and entitled “BACKGROUND DATA TRANSMISSION BETWEEN MEDIA DEVICE AND HOST DEVICE,” is hereby incorporated herein by reference. U.S. application Ser. No. 11/679,082, filed Feb. 26, 2007, and entitled “DATA SYNCHRONIZATION WITH HOST DEVICE IN ACCORDANCE WITH SYNCHRONIZATION PREFERENCES,” is hereby incorporated herein by reference. U.S. application Ser. No. 11/679,104, filed Feb. 26, 2007, and entitled “PRIORITIZED DATA SYNCHRONIZATION WITH HOST DEVICE,” is hereby incorporated herein by reference.

The advantages of the invention are numerous. Different embodiments or implementations may, but need not, yield one or more of the following advantages. One advantage of certain embodiments of the invention is that digital media assets, whether local or remote, can be presented to a user in a unified manner. In other words, to the extent that digital media assets are available they can be shown in a common graphical user interface. Another advantage of certain embodiments of the invention is that as certain digital media assets that are shown in a common graphical user interface become unavailable, they can be dynamically removed from being shown in the common graphical user interface.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for presenting a digital media asset on a media playback device, said method comprising:
obtaining a list of digital media assets that are available to the media playback device, at least one of the digital media assets being stored locally at the media playback device, and at least one of the digital media assets being stored remotely at a remote media management device;
presenting the list of digital media assets to a user of the media playback device;
receiving a selection of at least one of the digital media assets to be played;
determining whether the selected digital media asset is stored locally at the media playback device or stored remotely at the remote media management device;
if said determining determines that the selected digital media asset is stored remotely at the remote media management device, then streaming digital content of the selected digital media asset from the remote media management device to the media playback device so as to playback the selected digital media asset on the media playback device; and
if said determining determines that the selected digital media asset is stored locally at the media playback device, then retrieving digital content of the selected digital media asset from the media playback device so as to playback the selected digital media asset on the media playback device.

2. A method as recited in claim 1, wherein a user of the media playback device is not able to distinguish from the list of digital media assets whether the digital media assets in the list of digital media assets are stored locally or stored remotely.

3. A method as recited in claim 1, wherein said method comprises:
determining a preference setting for the media playback device, the preference setting for the media playback device being previously set at the remote media management device; and
wherein said presenting of the list of digital media assets to a user of the media playback device is dependent on the preference setting.

4. A method as recited in claim 3,
wherein when the preference setting is in a first state, said presenting of the list of digital media assets presents only those of the digital media assets that are available locally from the media asset player, and
wherein when the preference setting is in a second state, said presenting of the list of digital media assets presents those of the digital media assets that are available locally from the media asset player and those of the digital media assets that are available from the remote media management device.

5. A method as recited in claim 4, wherein a user of the media playback device is not able to distinguish from the list of digital media assets whether the digital media assets in the list of digital media assets are stored locally or stored remotely.

6. A method as recited in claim 1, wherein said streaming of the digital content of the selected digital media asset comprises:
retrieving a remote file location for the selected digital media asset;
opening a streaming connection between the media playback device and the remote media management device; and
initiating streaming playback of the digital content being received at the media playback device from the remote media management device via the streaming connection.

7. A method as recited in claim 1, wherein said method comprises:
determining whether a media source has been added or removed from the media playback device.

8. A method as recited in claim 1, wherein said method comprises:
determining whether the remote media management device is unavailable; and
subsequently modifying the list of digital media assets and refreshing said presenting of the list of digital media assets at least when said determining determines that the remote media management device has become unavailable.

9. A method as recited in claim 1, wherein when said determining determines that a media source is added or removed, said method further comprises:
repeating said obtaining and said presenting so that the list of digital media assets is updated in view of the digital media assets now available to the media playback device given that a media source has been added or removed.

10. A method as recited in claim 1, wherein the media playback device includes a display and said presenting operates to present the list of digital media assets.

11. A method as recited in claim 10, wherein the remote media management device is a personal computer operating a media management application.

12. A method as recited in claim 11, wherein a user of the media playback device is not able to distinguish from the list of digital media assets whether the digital media assets in the list of digital media assets are stored locally or stored remotely.

13. A method as recited in claim 1, wherein the digital media assets include at least a plurality of videos.

14. A method for dynamically displaying a list of digital media assets at a media playback device, said method comprising:
determining whether a remote media management device is available to the media playback device via a network connection;
obtaining a list of digital media assets that are available to the media playback device, the list including one or more digital media assets stored locally at the media playback device, and the list including at least one or more digital media assets stored remotely at the remote media management device provided it is determined that the remote media management device is available to the media playback device;
presenting the list of digital media assets to a user of the media playback device;
determining whether the remote media management device is no longer available to the media playback device; and
dynamically updating the list of digital media assets being displayed if it is determined that the remote media management device is no longer available to the media playback device, such that the list of digital media assets includes only the one or more digital media assets stored locally at the media playback device and thus no longer includes any digital media assets stored remotely at the remote media management device.

15. A method as recited in claim 14, wherein the network connection is a wireless network connection.

16. A method as recited in claim 14, wherein said presenting comprises displaying the list of digital media assets on a display device associated with the media playback device.

17. A method as recited in claim 14, wherein said method comprises:
subsequently determining whether the remote media management device which was not available to the media playback device is now available to the media playback device; and
dynamically updating the list of digital media assets being displayed if it is determined that the remote media management device is now available to the media playback device, such that the list of digital media assets includes not only the one or more digital media assets stored locally at the media playback device but also the one or more digital media assets stored remotely at the remote media management device.

18. A method as recited in claim 14, wherein said method comprises:
receiving a selection of at least one of the digital media assets to be played; and
determining whether the selected digital media asset is stored locally at the media playback device or stored remotely at the remote media management device.

19. A method as recited in claim 18, wherein said method comprises:
if said determining determines that the selected digital media asset is stored remotely at the remote media management device, then streaming digital content of the selected digital media asset from the remote media management device to the media playback device so as to playback the selected digital media asset on the media playback device; and
if said determining determines that the selected digital media asset is stored locally at the media playback device, then retrieving digital content of the selected digital media asset from the media playback device so as to playback the selected digital media asset on the media playback device.

20. A method as recited in claim 19, wherein a user of the media playback device is not able to distinguish from the list of digital media assets whether the digital media assets in the list of digital media assets are stored locally or stored remotely.

21. A method as recited in claim 20, wherein said method comprises:
determining a preference setting for the media playback device, the preference setting for the media playback device being previously set at the remote media management device; and
wherein said presenting of the list of digital media assets to a user of the media playback device is dependent on the preference setting.

22. A method as recited in claim 21,
wherein when the preference setting is in a first state, said presenting of the list of digital media assets presents only those of the digital media assets that are available locally from the media asset player, and
wherein when the preference setting is in a second state, said presenting of the list of digital media assets presents those of the digital media assets that are available locally from the media asset player and those of the digital media assets that are available from the remote media management device.
